(19) United States
(12) Patent Application Publication
(10) Pub. No.: US 2016/0207234 A1
(43) Pub. Date: Jul. 21, 2016

(54) SEMI-FINISHED PRODUCT, METHOD OF USING SAME, AND METHOD FOR PRODUCING A THREE-DIMENSIONALLY SHAPED HYBRID COMPONENT IN THE METAL/PLASTICS COMPOSITE

(71) Applicant: THYSSENKRUPP STEEL EUROPE AG, Duisburg (DE)

(72) Inventors: Torsten KRAHNERT, Fritzlar (DE); Lothar PATBERG, Moers (DE); Stefan MAYER, Schwerte (DE)

(73) Assignee: THYSSENKRUPP STEEL EUROPE AG, Duisburg (DE)

(21) Appl. No.: 14/915,438

(22) PCT Filed: Aug. 20, 2014
(86) PCT No.: PCT/EP2014/067763

§ 371 Date: Feb. 29, 2016

(30) Foreign Application Priority Data
Sep. 3, 2013 (DE) 10 2013 109 616.6

(51) Int. Cl. B29C 45/14; B32B 5/18; B32B 7/06; B32B 27/08; B32B 27/34; B32B 27/32; B32B 15/08; B32B 27/06

(52) U.S. Cl. CPC B29C 45/14311; B29C 45/14811; B29C 45/14221; B32B 15/08; B32B 5/18; B32B 27/065; B32B 27/08; B32B 27/34; B32B 27/32; B32B 7/06; B29K 2705/00

(57) ABSTRACT

Semi-finished products in the form of sheet bars or strips can undergo deep drawing and can produce three-dimensionally shaped hybrid components of metal/plastic composites. One example semi-finished product may comprise at least one metal sheet in the form of a sheet bar or a strip and at least one layer of thermoplastic applied in a material-bonding manner on the metal sheet. A side of the metal sheet on which the layer of plastic is applied may have a surface treated to improve the adherence of the layer of plastic. The layer of plastic of the semi-finished product may be formed as a coupling layer for material-bonding, adhesive-free attachment of at least one structural body produced from plastic. According to one example method, a plastic structural body may be molded in a material-bonding manner onto the layer of plastic formed as the coupling layer by injection molding or press-forming.

The invention relates to a semi-finished product in the form of a sheet or strip that can undergo deep drawing and is intended for producing a three-dimensionally shaped hybrid component of a metal/plastic composite and relates to a use of such a semi-finished product. The invention also relates to a method for producing a three-dimensionally shaped hybrid component of a metal/plastic composite.

In construction, and in particular in vehicle manufacture, highly use is made of lightweight components, which apart from low weight must additionally have high strengths and stiffness. Corresponding lightweight components often serve the purpose in a vehicle body of forming crash-related structural components, such as for instance a B pillar, a bumper or a side impact beam. One approach to achieving such lightweight components is to combine different materials with one another.

In the area of plastic and fiber-reinforced plastic, the company LANXESS AG has worked together with the Institute of Polymer Technology at Erlangen University in developing what is known as the “Erlanger beam”. This is a model beam that is used for standard tests, produced by heating an organometallic sheet (fiber-reinforced plastic) above its melting temperature, placing it into a forming mold, subjecting it to a forming process and subsequently providing it with a three-dimensional ribbed structure by an integrated injection-molding unit. With this model beam, the mechanical characteristic values are significantly higher than they are with a sheet-metal-based equivalent. As a result, such structures can absorb much more energy. Further three-point bending test simulations on the Erlanger beam have shown that a composite comprising a formed steel sheet with a ribbed structure corresponding to the Erlanger beam can absorb forces that are more than twice as high in comparison with the original variant of the Erlanger beam (organometallic sheet with a molded-on ribbed structure). Since, however, the metal and plastic are different types of material, suitable connecting measures have to be provided. The conventional production process comprises the following working steps:
1. fabricating (cutting to size) the steel sheet
2. subjecting the cut-to-size sheet to a forming process
3. deoiling the formed sheet
4. applying a layer of adhesive
5. transporting the formed, adhesive-coated sheet to the injection mold and placing it in the mold
6. back-injection-molding or injection-molding the sheet with plastic, with the result that a ribbed structure is produced.

This process is very costly. In particular, modern adhesives for the automobile industry are very expensive. All of this stops many automobile manufacturers or suppliers from using hybrid components of a metal/plastic composite, with the result that they cannot make use of the potential of lightweight construction that is available to this extent.

DE 199 34 545 C1 discloses hybrid components that comprise a profiled body shaped from a metal sheet bar that is back-injection-molded with plastic in such a way that the plastic defines a structural body comprising crossing ribs. To achieve an adequate connection between the metal and the plastic, according to DE 199 34 545 C1 a partial interlocking engagement of the plastic with the metal profiled body is produced. The interlocking engagement is achieved in this case by partial enclosure of the profiled body and by injection-molding of apertures in the profiled body. Anchoring points between the metal and the plastic are produced at the apertures. However, in the case of many components, these points of partial interlocking connection are undesired with regard to the outer appearance of the component. Moreover, the load-absorbing capability of such hybrid components is sometimes unsatisfactory because of the partial interlocking connections.

Against this background, the invention was based on the object of providing a semi-finished product for producing a three-dimensionally shaped hybrid component of a metal/plastic composite that enables automobile manufacturers or their suppliers to produce corresponding hybrid components with a high load-absorbing capability at a much lower cost than is the case with the aforementioned process comprising 6 working steps. The object was also to provide a low-cost method for producing a three-dimensionally shaped hybrid component of a metal/plastic composite.

With regard to the semi-finished product, the stated object is achieved by a semi-finished product with the features of claim 1. With regard to the method, the stated object is achieved by a method with the features of claim 18. Advantageous refinements of the semi-finished product according to the invention and of the method according to the invention are the subject of claims 2 to 17, which refer back to claim 1, and of claims 19 to 26, which refer back to claim 18.

The invention is based on the basic concept of providing for the production of a three-dimensionally shaped hybrid component of a metal/plastic composite a semi-finished product that allows a bonding between the metal and the plastic that adheres over substantially the full surface area without the need for the automobile manufacturer or hybrid component manufacturer to apply a layer of adhesive, in that the semi-finished product is made up of at least one metal sheet in the form of a sheet or strip and at least one layer of thermoplastic applied on it in a material-bonding manner, the side of the metal sheet on which the layer of plastic is applied having a surface that improves the adherence of the layer of plastic, and the layer of plastic being formed as a coupling layer for the material-bonding, adhesive-free attachment of at least one structural body produced or to be produced from plastic.

Depending on the surface treatment, various thermoplastics may be used as the coupling layer, in particular polypropylene (PP), polyamide (PA), polyethylene (PE), polyethylene terephthalate (PET), thermoplastic elastomer and compounds of these plastics, with polyamide, polyethylene or mixtures thereof being particularly preferred because of their relatively high thermal stability.

The metal sheet of the semi-finished product according to the invention is preferably produced from steel material, particularly preferably from dual-phase steel or from another lightweight steel. Steel material is distinguished by good formability and high strength. The microstructure of dual-phase steel consists primarily of a soft ferritic matrix, which incorporates islands of a second, hard, predominantly martensitic phase. The ferrite fraction accounts for up to 90%. Apart from martensite, there may also be fractions of residual austenite and bainite. Metal sheets of dual-phase steel are particularly suitable for cold-forming operations involving a high proportion of stretch forming for the production of strength-relevant structural elements and body parts. Hot-rolled dual-phase steel has advantages in particular for the weight-saving production of components such as profiles, body reinforcements and chassis parts. After an appropriate heat treatment, for example the treatment known as bake hardening, additional increases in strength of over 30 MPa are achieved.

The at least one metal sheet of the semi-finished product according to the invention has for example a thickness in the range of 0.1 to 2.5 mm, preferably 0.1 to 1.0 mm, particularly preferably in the range of 0.1 to 0.5 mm

On the other hand, the least one layer of plastic (coupling layer) of the semi-finished product according to the invention may be formed as rather thinner. It has for example a thickness in the range of 0.01 to 1.2 mm, preferably 0.05 to 1.0 mm, particularly preferably in the range of 0.3 to 0.8 mm.

In tests carried out on the part of the applicant it has been found that a semi-finished product according to the invention of which the metal sheet and the coupling layer have thicknesses in the ranges mentioned has good deep-drawing properties in the Erichsen cupping test at room temperature and a mold temperature of 100° C. During the deep drawing of the semi-finished product according to the invention, the layer of thermoplastic serving as the coupling layer flows along with the metal sheet, and in doing so does not lose its adhesion.

Instead of a metal sheet of steel material, the semi-finished product according to the invention may also comprise a metal sheet of magnesium or aluminum.

The function of the layer of thermoplastic (coupling layer) of the semi-finished product according to the invention is that it can be reliably connected in a material-bonding manner to many other plastics without applying an adhesive. In the injection-molding process, the energy of the plastics melt is used here for activating the surface of the coupling layer and producing the material bond. After the melt has cooled down, there is a perfect bond between the coupling layer and the molded-on plastic. The molded-on plastic may be not only a thermoplastic but also a thermoset and/or a plastic from the range of elastomers. It is also possible by plasma or corona pre-treatment before the injection-molding process to additionally activate the surface of the coupling layer in order to widen the range of plastics that can be used.

With the semi-finished product according to the invention, the working steps to be performed at the site of an automobile manufacturer or component supplier for producing a three-dimensionally shaped hybrid component are reduced considerably. This is so because, with the semi-finished product according to the invention, the automobile manufacturer or component supplier has in particular the possibility of producing a three-dimensionally shaped hybrid component by the following process steps:
1. fabricating (cutting to size) the semi-finished product in the form of a sheet or strip
2. transporting the cut-to-size semi-finished product to a forming mold with an integrated injection-molding unit and placing it in
3. forming and back-injection-molding the cut-to-size semi-finished blank in one step.

An advantageous refinement of the semi-finished product according to the invention is characterized in that the layer of plastic (coupling layer) does not cover the side of the metal sheet on which it is applied over the full surface area but partially. This refinement is expedient in particular whenever for example the hybrid component to be produced only partially has a strength- and/or stiffness-increasing ribbed structure of plastic. Consequently, one or more relatively large surface areas of the metal sheet that are not to have a ribbed structure after the completion of the hybrid component can remain uncoated during the coating of the metal sheet with the at least one layer of thermoplastic (coupling layer). This saves material costs and contributes to an optimized weight saving while maintaining adequate strength and stiffness properties.

A further advantageous refinement of the semi-finished product according to the invention is that the layer of thermoplastic is made double, a layer of thermoplastic foam being arranged between the two layers of plastic. It has been found that interposing a layer of thermoplastic foam can contribute greatly to reducing the weight of the hybrid component while maintaining the same strength and stiffness.

According to a further advantageous refinement, the layer of plastic (coupling layer) of the semi-finished product according to the invention is partially coated with at least one organometallic sheet. As a result, the strength and stiffness of the hybrid component to be produced can be greatly improved while maintaining the same overall weight or even with a reduced overall weight.

Alternatively or in addition, according to a further refinement of the semi-finished product according to the invention, its (at least one) metal sheet may also be coated on its side facing away from the layer of plastic (coupling layer) with at least one organometallic sheet. This refinement may also allow the strength and stiffness of the hybrid component to be produced to be increased greatly while maintaining the same overall weight or even with a reduced overall weight. At the same time, according to a further refinement, the organometallic sheet may be coated on its side facing away from the metal sheet with at least one second metal sheet. Hybrid components that are particularly lightweight and at the same time very strong and stiff can be produced from such a semi-finished product, in particular whenever, according to a preferred refinement, the organometallic sheet contains carbon fibers. Moreover, in a further refinement, the second metal sheet may be coated on the outside with a layer of thermoplastic, which is likewise formed as a coupling layer for the material-bonding, adhesive-free attachment of at least one structural body produced or to be produced from plastic. From a semi-finished product according to the invention designed in such a way, hybrid components that have structural bodies produced from plastic, in particular ribbed bodies, on both sides can be advantageously produced without applying an adhesive.

Another advantageous refinement of the semi-finished product according to the invention is that the metal sheet is coated on its side facing away from the layer of plastic with a second layer of thermoplastic, which is likewise formed as a coupling layer for the material-bonding, adhesive-free attachment of at least one structural body produced or to be produced from plastic. Also from such a semi-finished product according to the invention, hybrid components that have structural bodies produced from plastic, in particular ribbed bodies, on both sides can be produced without applying an adhesive.

In this case, the second layer of plastic (coupling layer) may cover the side of the metal sheet on which it is applied over the full surface area or partially. The partial coating of the metal sheet by the second layer of plastic is expedient for example whenever the hybrid component to be produced only partially has on the corresponding side of the metal sheet a ribbed structure of plastic that is attached in a material-bonding manner to the metal sheet without adhesive, by way of the partial coupling layer.

A further advantageous refinement of the semi-finished product according to the invention is that the second layer of plastic is coated on its side facing away from the metal sheet with a second metal sheet. In a further refinement, the second metal sheet may be coated on its side facing away from the second layer of plastic with a third layer of thermoplastic as a coupling layer. Also with semi-finished products according to the invention designed in such a way, lightweight hybrid components with high strength and stiffness can be produced at low cost. The same applies to a further refinement of the semi-finished product according to the invention, in which the second layer of plastic is coated over its full surface area or partially with at least one organometallic sheet.

According to a further refinement of the semi-finished product according to the invention, the respective layer of plastic, serving as a coupling layer, is provided with a protective film that can be peeled off. The protective film protects the surface of the coupling layer while the semi-finished product is being transported and possibly also while the semi-finished product is undergoing forming. As a result, there is no need for laborious cleaning of the coupling layer surface of contaminants such as oil or grease before plastic structures, for example plastic ribs, are molded on. Moreover, as a peeling film, the protective film can improve the sliding properties of the semi-finished product during the forming process.

The semi-finished product according to the invention is preferably formed as a flat product. It may be produced by means of a plate press in a static process, an interval heating press in a discontinuous process or a laminating system, for example a double belt press, in a continuous process. The process parameters are in this case respectively set specifically for the semi-finished product to be produced. Depending on variants of the semi-finished product, panels may be cut out from them; or the semi-finished product in strip form may be rolled up to a coil.

According to a second teaching of the present invention, the object presented above for a method for producing a three-dimensionally shaped hybrid component of a metal/plastic composite is achieved by using a semi-finished product according to the invention in one of the aforementioned refinements, a structural body of plastic being molded in a material-bonding manner onto the layer of plastic formed as a coupling layer by injection molding or press-forming.

As already stated, the semi-finished product according to the invention allows the production of a three-dimensionally shaped hybrid component from metal and plastic with a structural body, preferably a ribbed body, of plastic without applying adhesive. This greatly simplifies the production of the hybrid component.

An expedient refinement of the method according to the invention is that, before the structural body is molded on, the semi-finished product undergoes forming into a three-dimensional form. The forming process is in this case preferably performed by deep drawing or roll-forming.

A further advantageous refinement of the method according to the invention is characterized in that the semi-finished product undergoes forming by means of a forming mold, which has at least one integrated injection-molding cavity and at least one injection-molding channel entering the injection-molding cavity. This refinement offers the possibility of reducing the number of process steps for producing the hybrid component, in that the forming of the semi-finished product or cut-to-size semi-finished blank and the back-injection-molding of the coupling layer to produce the structural body, preferably a ribbed body, are carried out in the same process step.

Another advantageous refinement of the method according to the invention is characterized in that the semi-finished product undergoes forming by means of a forming mold, which has a profile with at least one integrated cavity for the pressing and three-dimensional shaping of a plastics compound. This variant also offers the possibility of reducing the number of process steps for producing the hybrid component, in that the forming of the semi-finished product or cut-to-size semi-finished blank and the pressing of the plastics compound to produce the structural body, preferably a ribbed body, on the coupling layer are carried out in the same process step.

A further variant of the method according to the invention is that the semi-finished product undergoes forming by roll-forming, a rotatable, wheel-shaped tool being used for the press-forming of the structural body during or after the forming of the semi-finished product, and the tool being provided with a profile having at least one cavity for the pressing and three-dimensional shaping of a plastics compound. With this refinement of the method, hybrid components of the type mentioned that are formed as sectional beams can in particular be mass produced effectively.

According to a further refinement of the method according to the invention, at least one integral flange that has the layer of thermoplastic formed as a coupling layer is formed on the hybrid component, a further hybrid component, configured as a metal/plastic composite, or an organometallic sheet being joined onto the layer of plastic by welding. In this way, hybrid components that are formed as half-shells for example can be put together at low cost to form a hollow channel or closed profile. The same applies correspondingly with regard to a combination of a hybrid component according to the invention with an organometallic sheet delimiting the hollow channel or the closed profile. The welded connection of the hybrid components formed as half-shells or the organometallic sheet to form a single hybrid component may be produced for example by friction welding, spot welding, ultrasonic welding, etc.

According to a third teaching of the present invention, the semi-finished product according to the invention is advantageously used for producing a three-dimensionally shaped hybrid component as a component for a vehicle, aircraft, ship or building structure. This is because the semi-finished product according to the invention has advantages wherever a weight saving is required, and for this purpose hybrid components of the type mentioned are to be produced in the fewest possible process steps.

The invention is explained in more detail below on the basis of a drawing representing several exemplary embodiments.

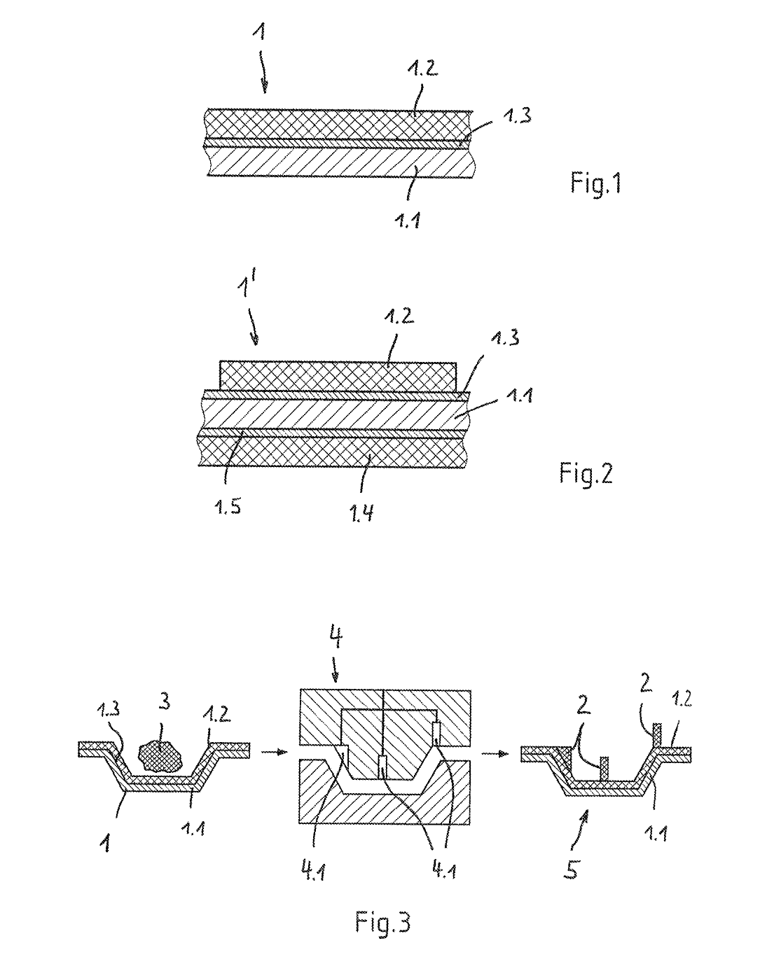

FIG. 1 schematically shows the basic structure of a semi-finished product 1 according to the invention for producing a three-dimensionally shaped hybrid component of a metal/plastic composite. The semi-finished product 1 is of a substantially flat form. It comprises at least one metal sheet 1.1 in the form of a sheet or strip, for example steel sheet, and at least one layer of thermoplastic 1.2 applied in a material-bonding manner on the metal sheet 1.1. The side of the metal sheet 1.1 on which the layer of plastic 1.2 is applied has a surface (boundary surface) 1.3 that improves the adhesion of the layer of plastic. For this purpose, the metal sheet has been subjected to a corresponding surface treatment. The surface treatment may be in particular a plasma treatment, plasma coating, corona treatment or the application of a layer in a coil-coating process. The material-bonding connection of the metal sheet 1.1 and the layer of plastic 1.2 preferably takes place without adhesive. The adhesion of the layer of plastic 1.2 is so great that the layer of plastic 1.2 is not detached from the metal sheet 1.1 while the semi-finished product 1 is undergoing the forming process.

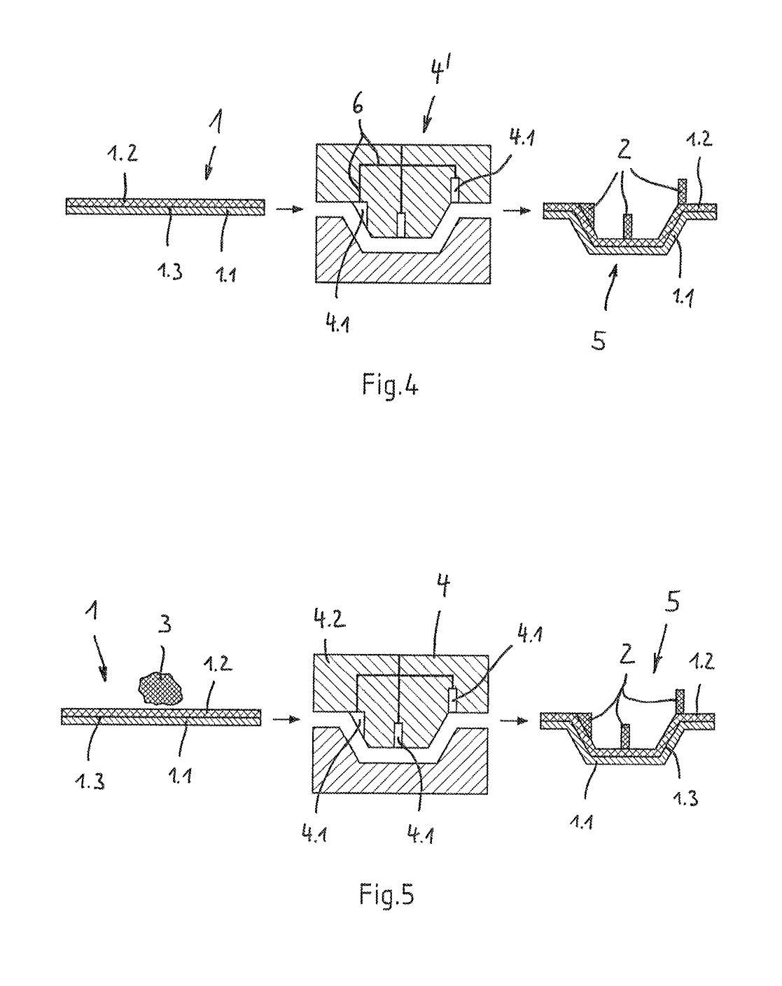

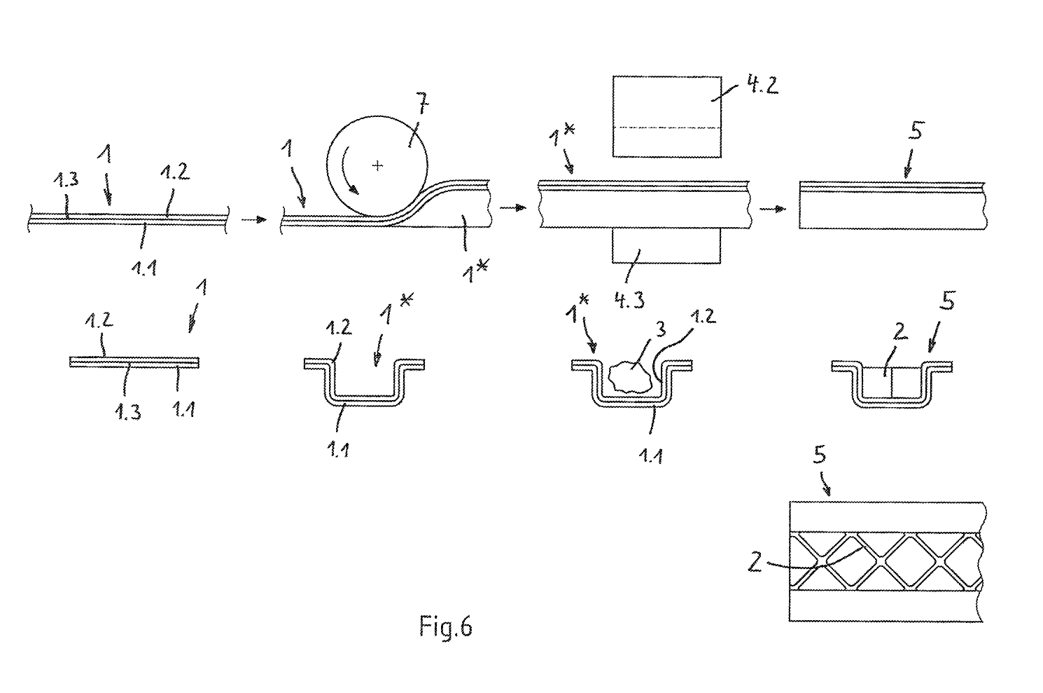

The layer of thermoplastic 1.2 applied in a material-bonding manner to the metal sheet 1.1 serves as a coupling layer for the material-bonding, adhesive-free attachment of at least one structural body 2 produced or to be produced from plastic, for example a ribbed body (cf. in particular FIG. 4 and FIG. 6). The layer of thermoplastic 1.2 consists for example of polyamide, polyethylene or a compound of these plastics and has a thickness in the range of 0.01 to 1.2 mm, preferably 0.05 to 1.0 mm, particularly preferably in the range of 0.3 to 0.8 mm. The flat semi-finished product 1 can undergo deep drawing and is provided for further processing in plate form or as a coil.

In the case of the semi-finished product 1′ that is schematically represented in FIG. 2, the metal sheet (for example steel sheet) 1.1 is coated on both sides with a layer of thermoplastic 1.2, 1.4 serving as a coupling layer, in a way corresponding to FIG. 1. For this purpose, the metal sheet 1.1 has previously been surface-treated on both sides, in order to achieve a reliable adhesion of the respective layer of plastic 1.2, 1.4 on the metal sheet 1.1. The surface-treated surfaces (boundary surfaces) are denoted by 1.3 and 1.5. As shown in FIG. 2, at least one (1.2) of the thermoplastic coupling layers may only partially cover the metal sheet 1.1.

The semi-finished product 1, 1′ may be processed in conventional presses for metal forming processes. The at least one thermoplastic coupling layer 1.2 or 1.4 may exert a sliding effect here, with the result that it is possible to dispense with customary lubricants and sliding agents, such as for instance deep-drawing oils. The forming process may be performed conventionally in a cold state, but also analogously with the semi-finished product 1, 1′ heated up before the pressing process, in that the semi-finished product is heated in a corresponding temperature-control unit, for example a furnace. Alternatively or in addition, the semi-finished product or fabricated workpiece 1, 1′ may also be heated within the forming mold.

Then, in a downstream process step, the formed semi-finished product (workpiece) 1, 1′ is provided with a structural body, for example a ribbed body, of plastic, the structural body (ribbed body) 2 being molded in a material-bonding manner onto the coupling layer 1.2 and/or 1.4 without adhesive. This may take place by injection molding or, as schematically shown in FIG. 3, by compression molding of a plasticized plastics compound 3. The shaping mold 4 is provided for this purpose with a profile, having a corresponding cavity 4.1, for the pressing and three-dimensional shaping of the plastics compound 3. After opening of the shaping mold 4, the finished hybrid component 5 can be removed.

In the case of the exemplary embodiment that is schematically represented in FIG. 4, a fabricated semi-finished product 1 according to the invention is subjected to a forming process and back-molded with plastic by means of an integrated injection-molding device 6 in the closed state of the forming mold 4′ in one process step. For this purpose, the semi-finished product 1 is heated to a specific temperature level, in order to allow an optimum connection between the coupling layer of the semi-finished product 1 and the plastic structure 2 to be produced by injection molding. The molten plastics compound is injected under pressure by means of the injection-molding device 6 onto the coupling layer 1.2 of the formed semi-finished product 1, shaping elements or cavities 4.1 formed in the forming mold bringing about the desired final contour of the molded-on plastic structure. After opening of the shaping mold 4, the finished hybrid component 5 can be removed.

In the case of the exemplary embodiment that is schematically represented in FIG. 5, the three-dimensional structural body 2, for example a ribbed body, of the hybrid component 5 is in turn produced by compression molding of a plastics compound 3. In this example, the plastics compound 3 is placed onto the flat semi-finished product 1 that has not yet undergone forming. The shaping of the plastics compound 3 takes place during the forming of the semi-finished product 1 within the forming mold 4. For this purpose, the punch 4.2 of the mold 4 has a profile with at least one integrated cavity 4.1 for the pressing and three-dimensional shaping of the plastics compound 3. After opening of the shaping mold 4, the finished hybrid component 5 is removed.

A further exemplary embodiment of a production according to the invention of a hybrid component 5 of a metal/plastic composite is schematically shown in FIG. 6. The hybrid component 5 is in this case produced by using roll-forming. A semi-finished product 1 according to the invention in the form of a strip or of an elongate form is formed into a profile 1*, for example a U profile or a top-hat profile, by means of a roll-forming device 7. Then, in the formed semi-finished product 1 (profile 11, a plastics compound is applied to its coupling layer 1.2 and is subsequently shaped into a three-dimensional structural body or ribbed body 2 by means of a press having a punch 4.2 and a die 4.3.

The embodiment of the invention is not restricted to the exemplary embodiments that are schematically represented in the drawing. Rather, numerous variants are possible, including making use of ways of implementing the invention specified in the claims that differ from the drawing. For instance, the semi-finished product 1, 1′ according to the invention may in particular also have at least one further layer of metal sheet, layer of plastic (coupling layer) and/or layer of organometallic sheet. Furthermore, it is within the scope of the invention to form the semi-finished product 1, 1′ by roll-forming, a rotatable, wheel-shaped tool being used for the press-forming of the structural body 2 during or after the forming of the semi-finished product, and the tool being provided with a profile having at least one cavity for the pressing and three-dimensional shaping of a plastics compound 3.

1.-27. (canceled)

28. A method for producing three-dimensionally shaped hybrid components of a metal/plastic composite, the method comprising:
using a semi-finished product configured as a metal sheet or a metal strip and capable of undergoing deep drawing;
treating a side of the semi-finished product to improve adhesion;
applying at least one thermoplastic layer in a material-bonding manner to the treated side of the semi-finished product, the at least one thermoplastic layer being formed as a coupling layer for attachment of at least one structural body produced from plastic; and
injection molding or press-forming the at least one structural body onto the at least one thermoplastic layer in a material-bonding, adhesive-free manner.

29. The method of claim 28 further comprising forming the semi-finished product into three-dimensional form before injection molding or press-forming the at least one structural body onto the at least one thermoplastic layer.

30. The method of claim 29 wherein forming the semi-finished product into three-dimensional form is performed by deep drawing or roll-forming.

31. The method of claim 29 wherein forming the semi-finished product into three-dimensional form is performed by a forming mold having at least one integrated injection-molding cavity and at least one injection-molding channel entering the injection-molding cavity.

32. The method of claim 29 wherein forming the semi-finished product into three-dimensional form is performed by a forming mold having a profile with at least one integrated cavity for pressing and three-dimensionally shaping a plastics compound.

33. The method of claim 28 further comprising forming the semi-finished product into three-dimensional form by roll-forming, wherein a rotatable wheel-shaped tool is used to press-form the at least one structural body during or after the forming of the semi-finished product, wherein the rotatable wheel-shaped tool comprises a profile with at least one cavity for pressing and three-dimensionally shaping a plastics compound.

34. The method of claim 28 further comprising:
forming on a first three-dimensionally shaped hybrid component at least one integral flange having the at least one thermoplastic layer as the coupling layer; and
welding a second three-dimensionally shaped hybrid component configured as a metal/plastic composite or an organometallic sheet onto the at least one thermoplastic layer of the first three-dimensionally shaped hybrid component.

35. The method of claim 34 wherein the first and second three-dimensionally shaped hybrid components form a hollow channel or a closed profile.

36. The method of claim 35 wherein the second three-dimensionally shaped hybrid component is configured as the organometallic sheet.

37. The method of claim 28 wherein the metal sheet of the semi-finished product has a thickness of 0.1 to 1.0 mm.

38. The method of claim 28 further comprising producing the at least one thermoplastic layer from at least one of polyamide, polyethylene, polypropylene, or a thermoplastic elastomer.

39. The method of claim 28 wherein the at least one thermoplastic layer has a thickness of 0.05 to 1.0 mm.

40. The method of claim 28 wherein applying the at least one thermoplastic layer to the treated side of the metal sheet of the semi-finished product partially covers the treated side of the metal sheet.

41. The method of claim 28 wherein the at least one thermoplastic layer includes a first thermoplastic layer and a second thermoplastic layer, wherein a layer of thermoplastic foam is disposed between the first and second thermoplastic layers.

42. The method of claim 28 wherein the at least one thermoplastic layer is at least partially coated with an organometallic sheet.

43. A semi-finished product configured to undergo deep drawing and intended for producing a three-dimensionally shaped hybrid component of a metal/plastic composite, the semi-finished product comprising:
at least one metal sheet in the form of a sheet or strip; and
at least one thermoplastic layer applied in a material-bonding manner on a side of the at least one metal sheet, wherein the side of the at least one metal sheet is treated for adhering to the at least one thermoplastic layer, wherein the at least one thermoplastic layer is a coupling layer configured for material-bonding adhesive-free attachment of at least one plastic structural body.

44. The semi-finished product of claim 43 wherein the at least one thermoplastic layer comprises a first thermoplastic layer and a second thermoplastic layer, wherein a layer of thermoplastic foam is disposed between the first and second thermoplastic layers.

45. The semi-finished product of claim 43 wherein the at least one thermoplastic layer is partially coated with at least one organometallic sheet.

46. The semi-finished product of claim 43 further comprising an organometallic sheet disposed on a side of the at least one metal sheet opposite the side on which the at least one thermoplastic layer is applied.

47. The semi-finished product of claim 43 further comprising a peelable protective film disposed on the at least one thermoplastic layer on a side that receives the at least one plastic structural body.
